(19) United States
(12) Patent Application Publication
(10) Pub. No.: US 2007/0187430 A1
(43) Pub. Date: Aug. 16, 2007

(54) Squeezing device for removing contents from soft tube

(76) Inventor: Raydon Chen, Hsin-Den City (TW)

Correspondence Address: BIRCH STEWART KOLASCH & BIRCH, PO BOX 747, FALLS CHURCH, VA, 22040-0747, US

(21) Appl. No.: 11/350,871

(22) Filed: Feb. 10, 2006

(51) Int. Cl. B65D 35/56; B67D 5/06; B65D 37/00

(52) U.S. Cl. 222/105; 222/183; 222/206

(57) ABSTRACT

A squeezing device for removing contents from a soft tube includes a squeezable body with an open top and a close bottom so that the soft tube is received in the squeezable body. A cover has a mounting portion and a passage is defined through the mounting portion. The mounting portion is connected to the open top of the squeezable body and an opening of the soft tube is engaged with the passage. By squeezing the squeezable body, the soft tube in the squeezable body is squeezed and the contents in the soft tube are squeezed out from the passage. A cap is pivotably connected to the cover so as to pivotably seal the passage when not in use.

### BACKGROUND OF THE INVENTION

1. Field of the Invention

The present invention relates to a squeezing device for removing contents in a soft tube by squeezing the soft tube.

2. The Prior Arts

Some fluid products such as toothpaste or body lotion are received in soft packages such as soft tubes and these products are squeezed out from the soft tubes by users from an opening at an end of the soft tubes. However, the soft tube has a nature to bounce back to its original shape after it is squeezed and air is sucked into the soft tube. The air in the soft tube makes the amount of the product of the next squeeze to be difficult to control. The air in the soft tube forms a pressure in the soft tube and the pressure might suddenly push the product out from the opening of the soft tube when the soft tube is squeezed. Besides, the users cannot tell how much the product remains in the soft tube if the soft tube is not made by transparent material. The remained product in the soft tube can only be squeezed out by squeezing devices which have several types in the market. One of the conventional squeezing devices is independent from the soft tube so that the users have to purchase separately and to engage with the soft tube to use it. Another type of the squeezing device is connected to an end of the soft tube and is in a form of a clamp which can roll the soft tube or move along the soft tube to squeeze the remained product out from the soft tube. The clamp-type squeezing device includes several parts which involve high manufacturing cost. The clamp-type squeezing device cannot be used with those soft tubes without caps.

The present invention intends to provide a squeezing device which includes a squeezable body in which the soft tube is received and a cover which is engaged with the opening of the soft tube so that the soft tube can be squeezed by squeezing the body of the device.

### SUMMARY OF THE INVENTION

The present invention relates to a squeezing device which comprises a squeezable body having an open top and a close bottom. The squeezable body is composed of continuous foldable portions which are foldable axially. A cover has a mounting portion and a passage is defined through the mounting portion. A cap is pivotably connected to the cover and may pivotably seal the passage. The mounting portion is connected to the open top of the squeezable body.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded view of a squeezing device in accordance with the present invention;

FIG. 2 is a cross-sectional view of the squeezing device of the present invention;

FIG. 3 shows that a soft tube is received in the squeezing device;

FIG. 4 is a cross-sectional view to show the soft tube received in the squeezing device;

FIG. 5 shows that the paste in the soft tube is squeezed out from a passage of a cover of the squeezing device;

FIG. 6 shows that users can hold a flange of the cover and squeeze a squeezable body of the squeeze device;

FIG. 7 shows that the squeezable body is a substantially rectangular body, and

FIG. 8 shows that the squeezable body is composed of a continuous wave-shaped part.

### DETAILED DESCRIPTION OF THE PREFERRED EMBODIMENT

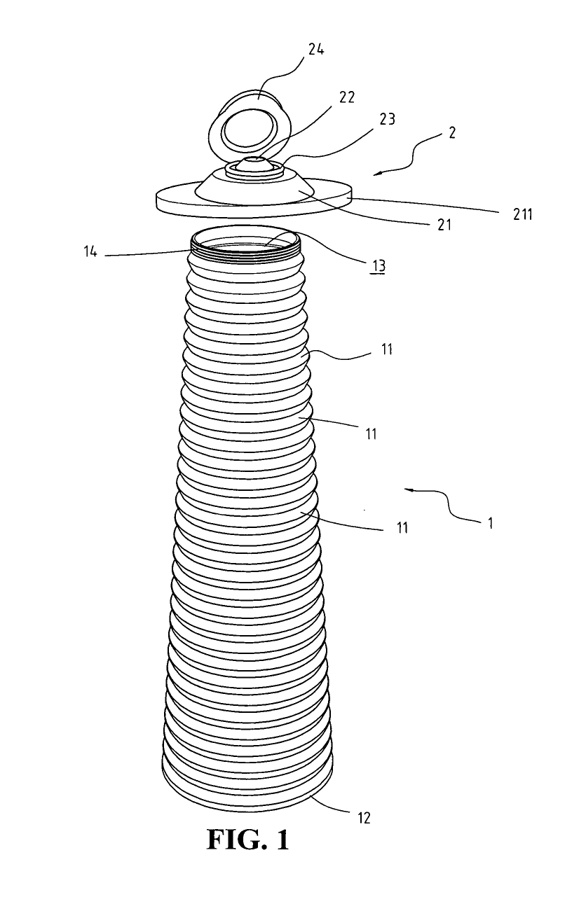

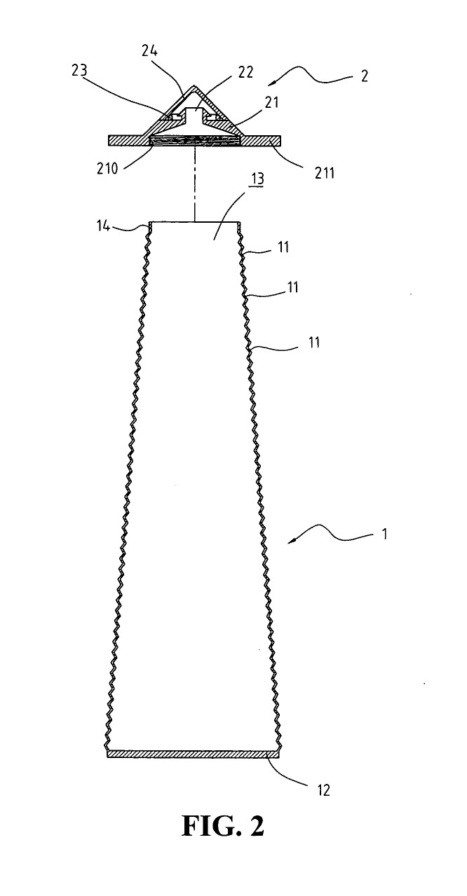

With reference to the drawings and in particular to FIGS. 1 and 2, a squeezing device in accordance with the present invention comprises a squeezable body 1 and a cover 2, wherein the squeezable body 1 is composed of continuous foldable portions 11 which are foldable axially. The squeezable body 1 is a substantially circular tube and has an open top 13 and a close bottom 12. A diameter of the open top 13 is smaller than that of the close bottom 12 of the squeezable body 1. A threaded outer periphery 14 is defined in an outer periphery of the open top 13.

The cover 2 has a mounting portion 21 and a passage 22 is defined through the mounting portion 21. A threaded inner periphery 210 is defined in an inner periphery of the mounting portion 21 so that the mounting portion 21 can be connected to the open top 13 of the squeezable body 1 by engaging the threaded outer periphery 14 with the threaded inner periphery 210. A cap 24 is pivotably connected to the cover 2 and a neck 23 extends from a top of the mounting portion 21. The cap 24 is disengagably engaged with the neck 23 so as to pivotably seal the passage 22. The cover 2 further includes a flange 211 extending outward from the mounting portion 21.

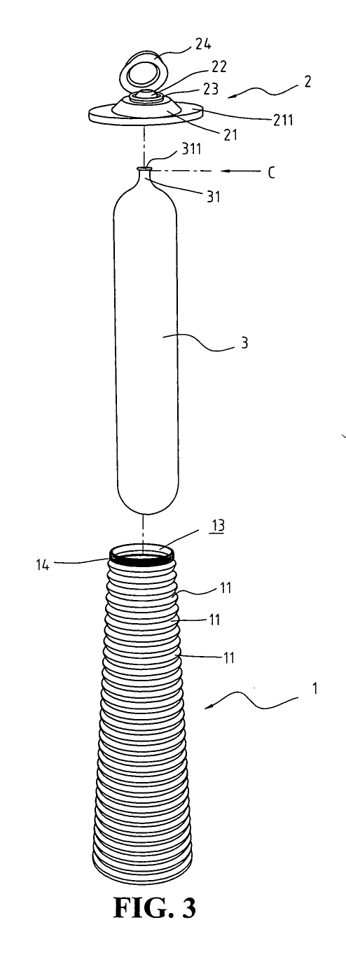

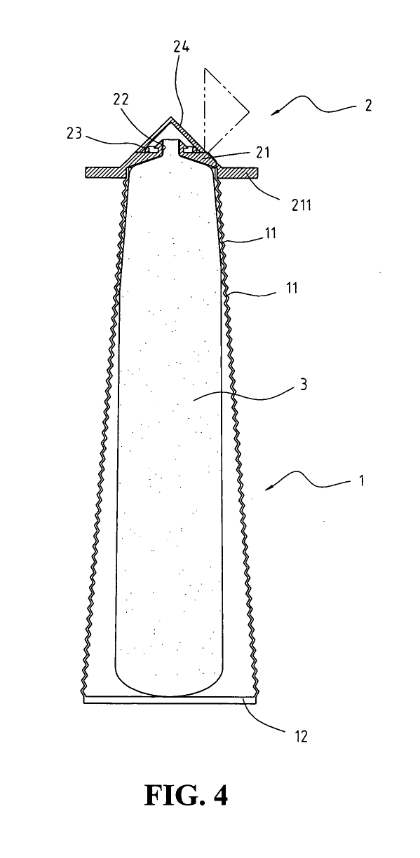

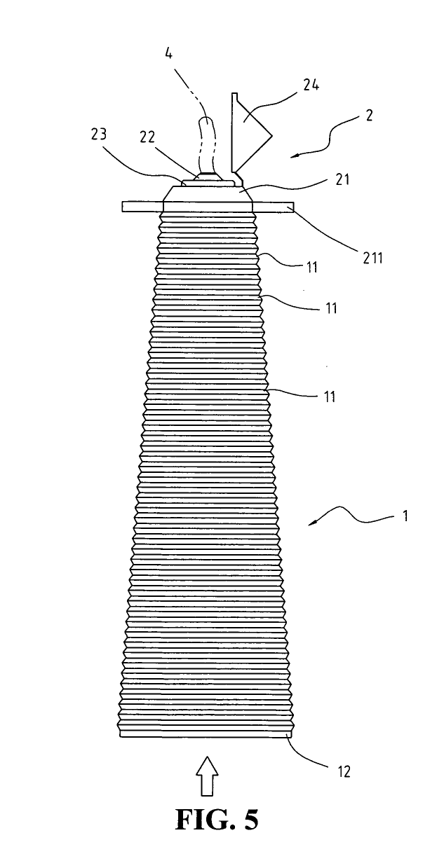

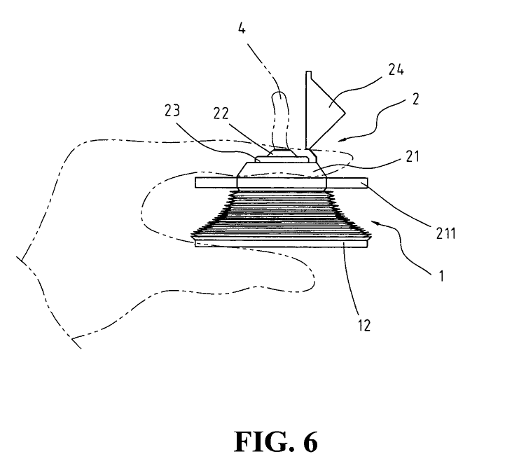

Referring to FIGS. 3-6, a soft tube 3 is received in the squeezable body 1 from the open top 13 and a seal 311 of the soft tube 3 is cut from the position designated by a phantom line “C”. The cover 2 is threadedly connected to the open top 13 of the squeezable body 1 by engaging the threaded outer periphery 14 with the threaded inner periphery 210. The soft tube 3 includes an outlet 31 which is inserted into the passage 22 and can be sealed by closing the cap 24. The contents in the soft tube 3 can be squeezed out from the outlet 31 via the passage 22 by squeezing the squeezable body 1 as shown in FIG. 5. After the soft tube 3 is used for a period of time and only a small amount of the contents are remained in the soft tube 3, users can squeeze the squeezable body 1 and the soft tube 3 axially by using the thumb at the close bottom 13 and the rest fingers on the flange 211. By this way, the soft tube 3 can be completely squeezed and the contents can be expelled out from the soft tube 3.

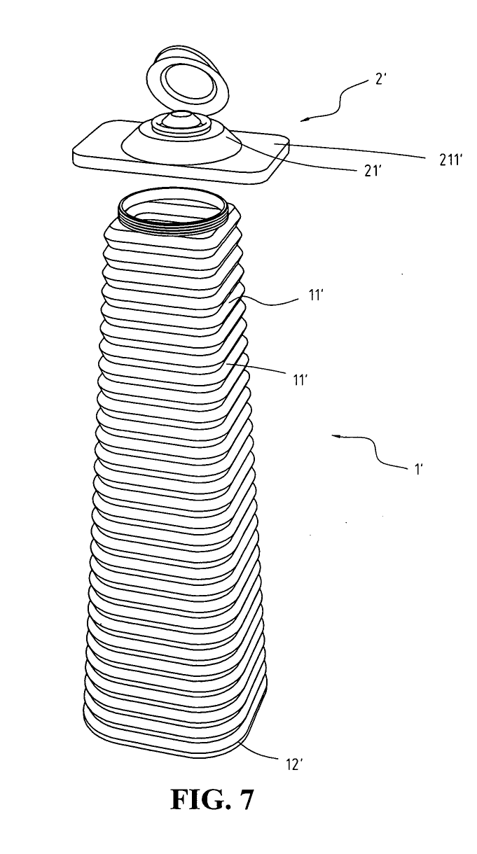

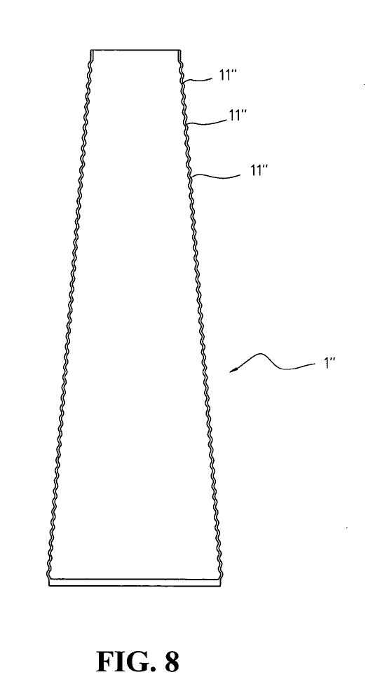

FIG. 7 shows that the squeezable body 1′ can be a substantially rectangular tube with rectangular foldable parts 11′. The cover 2′ includes a rectangular flange 211′ and the mounting portion 21′ is a circular mounting portion. FIG. 8 shows that the squeezable body 1″ can be composed of a continuous wave-shaped part 11″.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A squeezing device for removing contents from a soft tube, comprising:
a squeezable body having an open top and a close bottom, the squeezable body composed of continuous foldable portions which are foldable axially; and
a cover having a mounting portion and a passage defined through the mounting portion, a cap pivotably connected to the cover and pivotably sealing the passage, the mounting portion being connected to the open top of the squeezable body.

2. The device as claimed in claim 1, wherein a threaded outer periphery is defined in an outer periphery of the open top and a threaded inner periphery is defined in an inner periphery of the mounting portion, the mounting portion is connected to the open top of the squeezable body by engaging the threaded outer periphery with the threaded inner periphery.

3. The device as claimed in claim 1, wherein the squeezable body is a substantially circular tube.

4. The device as claimed in claim 1, wherein the squeezable body is a substantially rectangular tube.

5. The device as claimed in claim 1, wherein a diameter of the open top is smaller than that of the close bottom of the squeezable body.

6. The device as claimed in claim 1, wherein a neck extends from a top of the mounting portion and the cap is disengagably engaged with the neck.

7. The device as claimed in claim 1, wherein the cover includes a flange extending outward from the mounting portion.

8. The device as claimed in claim 1, wherein the squeezable body is composed of a continuous wave-shaped part.
